(19) United States
(12) Patent Application Publication
(10) Pub. No.: US 2006/0195363 A1
(43) Pub. Date: Aug. 31, 2006

(54) Persistent object for online activities

(75) Inventors: Alexandra K. Heron, Kirkland, WA (US); David Michael Miller, Redmond, WA (US); Eric L. Matteson, Redmond, WA (US); John S. Holmes, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/065,866

(22) Filed: Feb. 25, 2005

(51) Int. Cl. G06Q 99/00; G06Q 30/00

(52) U.S. Cl. 705/26; 705/1

(57) ABSTRACT

A persistent object for online activities is described. In an implementation, a method is described in which a persistent object is created which references a plurality of clients for participation in an online activity over a network. The persistent object is stored to be callable by at least one of the client for initiating the online activity and causing a notification to be formed for communication over the network to each of the other clients to participate in the online activity.

### TECHNICAL FIELD

The present invention generally relates to activities performed over a network and more particularly relates to a persistent object for online activities.

### BACKGROUND

A user has access to a variety of online activities which are accessible over a network. For example, the user may play an online game, participate in an instant messaging session, and so on. Additionally, the user may participate in the online activity with a number of other users. For instance, a plurality of users may each access an online poker game and play against each other, participate in an online meeting, and so forth. Because the online activity is accessible via a network, the users may access the online activity from a wide variety of geographical locations.

Traditional online activities, however, were joined by the users on an ad hoc basis such that the users manually joined the activity each time participation in the online activity was desired. For example, users were forced to manually coordinate with other users to specify a particular online activity, when to participate in the online activity, where the online activity is located, and so on. Thus, this ad hoc basis may require that each user perform multiple manual steps in order to participate in the online activity, which may be further complicated by the potential dispersal of the users across the wide variety of geographical locations. Further, even after performance of the multiple steps, the user was not guaranteed that other desired users were available to participate in the online activity. Accordingly, the multiple steps often resulted in user frustration and consequently users often avoided performing these steps to participate in the online activity.

Therefore, there is a continuing need for improved techniques for specifying a group of clients to participate in an online activity.

### SUMMARY

A persistent object for online activities is described. In an implementation, a method is described in which a persistent object is created which references a plurality of clients for participation in an online activity over a network. The persistent object is stored to be callable by at least one of the clients for initiating the online activity and causing a notification to be formed for communication over the network to each of the other clients to participate in the online activity.

In another implementation, a method is described in which a persistent object is examined to locate a plurality of clients which are to participate in an instant messaging session. A notification is formed for communication to one or more of the clients which indicates that participation in the instant messaging session is available.

### BRIEF DESCRIPTION OF THE DRAWINGS

FIG. 1 is an illustration of an environment in an exemplary implementation that is operable to employ the persistent object techniques for online activities.

FIG. 2 is an illustration of a system in an exemplary implementation showing an online activity provider, clients, persistent object system, and authentication system of FIG. 1 in greater detail as providing an online activity which includes instant messaging.

FIG. 3 is a flow diagram depicting a procedure in an exemplary implementation in which a persistent object is created by a client to automatically cause notifications to be configured for other clients referenced by the persistent object.

FIG. 4 is a flow diagram depicting a procedure in an exemplary implementation in which a client receives a notification configured by the procedure of FIG. 3 to participate in an online activity.

FIG. 5 is a flow diagram depicting a procedure in an exemplary implementation in which an instant messaging session is initiated for participation by a plurality of clients over a peer-to-peer network.

FIG. 6 is an illustration of an exemplary implementation in which a first client of FIG. 2 executes the messaging module to output a user interface for initiating participation in a discussion group in conjunction with an instant messaging session.

FIG. 7 is an illustration of an exemplary implementation in which the first client of FIG. 6 is communicatively coupled to a second client over the peer-to-peer network of FIG. 2.

FIG. 8 is an illustration of an exemplary implementation in which a user interface of the second client of FIG. 7 is shown as outputting the notification received from the first client.

FIG. 9 is an illustration of an exemplary implementation in which the user interface of the first client and the user interface of the second client each output notifications which relate to the change in presence of the discussion group.

FIG. 10 is an illustration of an exemplary implementation in which another one of the plurality of clients of FIG. 2, when available to participate in the instant messaging session, outputs a notification received from the first client.

FIG. 11 is an illustration of an exemplary embodiment in which user interfaces are shown for the respective first, second, and third clients which output notifications that relate to the change in presence of the group.

The same reference numbers are utilized in instances in the discussion to reference like structures and components.

### DETAILED DESCRIPTION

Overview

A persistent object for online activities is described. Currently, online activities are typically performed by a single user or a group that is created on an ad hoc basis. Therefore, to participate in the online activity, each user is required to perform multiple steps, a result of which may be that no other users are even available to participate in the online activity. This may result in user frustration, even to the point that the users choose to forgo participation in the online activity. Thus, the online activity may be underutilized, which also results in lost business opportunities by a provider of the online activity.

In a plurality of implementations, techniques are described for creating and storing a persistent object (e.g., a data structure) which references users which are desired for participation in an online activity. The persistent object may be stored and called by any of the users to initiate group participation in the online activity. When called by a user, for instance, the persistent object may be examined to determine which other users are to receive a notification of the online activity. Notifications may then be sent to the users to invite participation in the online activity. In an implementation, the notification is selectable by the user to cause automatic participation in the online activity. When one or more of the other users begin participation in the online activity, each user that is already participating in the online activity may be informed as to the addition of the user. Additionally, the user which has logged-on to participate in the online activity may be informed as to an action, if any, which was performed by each of the participating users in conjunction with the online activity. In this way, each user may be informed as to the current status of the online activity. In the following discussion, an exemplary environment is first discussed which is operable to employ the persistent object techniques for online activities. Exemplary procedures are then discussed, which are operable in the exemplary environments as well as in other environments.

Exemplary Environment

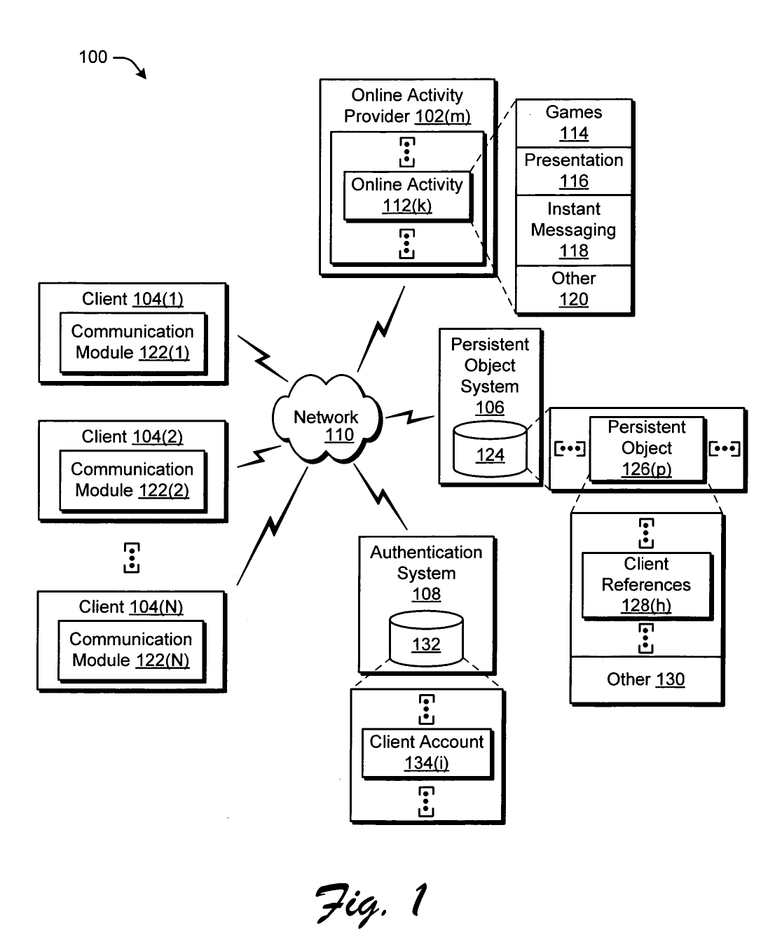

FIG. 1 is an illustration of an environment 100 in an exemplary implementation that is operable to employ the persistent object techniques for online activities. The illustrated environment 100 includes a plurality of online activity providers 102(m) (where “m” can be any integer from one to “M”) a plurality of clients 104(1), 104(2), . . . , 104(N), a persistent object system 106, and an authentication system 108, each of which are communicatively coupled, one to another, over a network 110. The clients 104(1)-104(N) may be configured in a variety of ways. For example, one or more of the clients 104(1)-104(N) may be configured as a computing device that is capable of communicating over the network 110, such as a desktop computer, a mobile station, an entertainment appliance, a set-top box communicatively coupled to a display device, a wireless phone, a game console, and so forth. Thus, the clients 104(1)-104(N) may range from full resource devices with substantial memory and processor resources (e.g., personal computers, game consoles) to low-resource devices with limited memory and/or processing resources (e.g., traditional set-top boxes, hand-held game consoles). The clients 104(1)-104(N) may also relate to a person and/or entity that operate the clients. In other words, clients 104(1)-104(N) may describe logical clients that include users, software and/or devices.

Although the network 110 is illustrated as the Internet, the network may assume a wide variety of configurations. For example, the network 110 may include a wide area network (WAN), a local area network (LAN), a wireless network, a peer-to-peer network, a public telephone network, an intranet, and so on. Further, although a single network 110 is shown, the network 110 may be configured to include multiple networks. For instance, the online activity provider 102(m) and the persistent object system 106 may be communicatively coupled via a corporate Intranet to communicate, one to another. Additionally, both the online activity provider 102(m) and the persistent object system 106 may be communicatively coupled to the clients 104(1)-104(N) over the Internet. A wide variety of other instances are also contemplated.

The online activity provider 102(m) is illustrated as including a plurality of online activities 112(k) which is accessible by the plurality of clients 104(1)-104(N) over the network 110. The online activities 112(k) may be configured in a wide variety of ways. For example, the online activity 112(k) may be configured as a game 114 (e.g., online poker, interactive role playing games, bridge, chess, and so on), a presentation 116 (e.g., a slideshow presentation shown to the plurality of clients 104(1)-104(N), and so on), instant messaging 118, and other 120 online activities , such as online meetings.

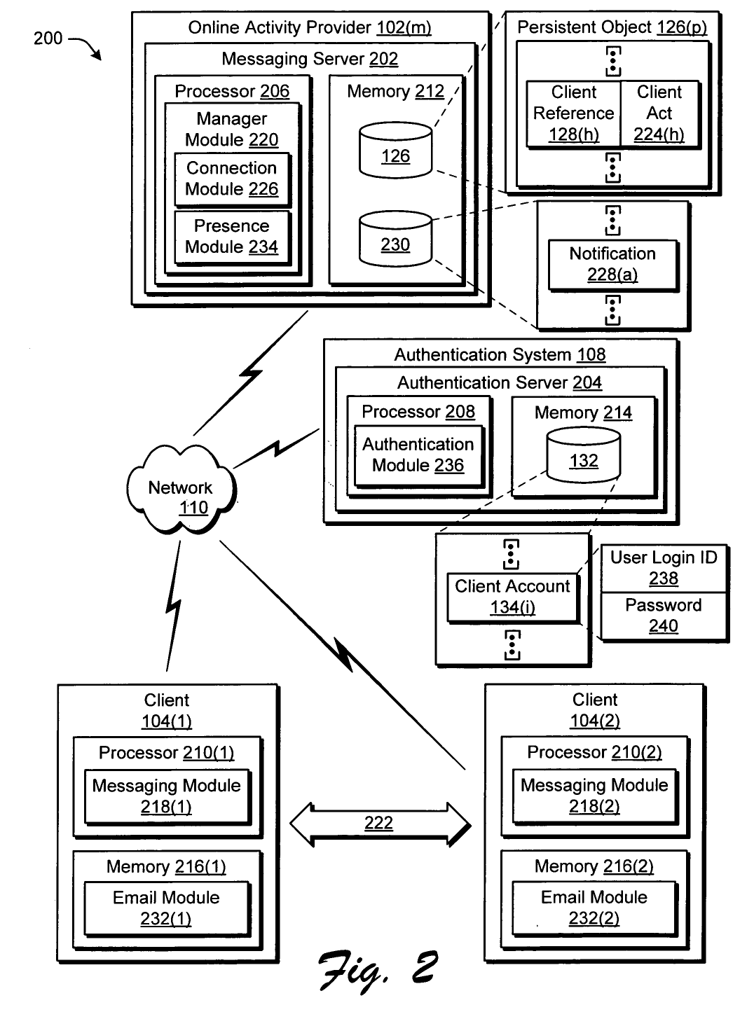

Each of the plurality of clients 104(1)-104(N) is illustrated as including a respective one of a plurality of communication modules 122(1)-122(N). Each of the communication modules 122(1)-122(N) is executable to participate in the online activity 112(k) over the network 110. Although a single communication module 122(1)-122(N) is shown for each of the respective clients 104(1)-104(N), the communication modules 122(1)-122(N) may represent functionality that may be provided by a plurality of modules, further discussion of which may be found in relation to FIG. 2.

The environment 100 is further illustrated as including the persistent object system 106, which is accessible by the plurality of clients 104(1)-104(N) and/or the online activity provider 102(m) over the network 110. The persistent object system 106 is represented as having storage 124 for a plurality of persistent objects 126(p), where “p” can be any integer from one to “P”. Each of the plurality of persistent objects 126(p) is persistent such that it continues to exist beyond termination of execution of a module that created the persistent object and/or continues to exist past a session, during which, the persistent object was created. For example, the communication module 122(1) may be executed on the client 104(1) to form and store the persistent object 126(p). Therefore, even if execution of the communication module 122(1) is terminated, the persistent object may be called the next time the client 104(1) “logs on”.

The persistent object 126(p) includes a plurality of client references 128(h), where “h” can be any integer from one to “H”. Each client reference 128(h) corresponds to one of the plurality of clients 104(2)-104(N) that the client 104(1) desires to include for participation in the online activity 112(k). Additionally, the plurality of client references 128(h) may include a client reference to the creator of the persistent object 126(p), e.g., client 104(1). Therefore, the persistent object 126(p) may be called by one of the other clients to include the original creator of the persistent object.

The persistent object 126(p), after creation, may be stored in storage 124 such that even after termination of the execution of the communication module 122(1), the persistent object 126(p) (and more particularly data included in the persistent object) may be utilized to initiate group participation in the online activity 112(k) by the clients 104(1)-104(N) referenced by the client references 128(h). The persistent object 126(p) may also include other 130 data, such as another persistent object for another grouping, one or more actions performed by each client 104(1)-104(N) referenced by the client references 128(h) during participation in the online activity 112(k), and so on.

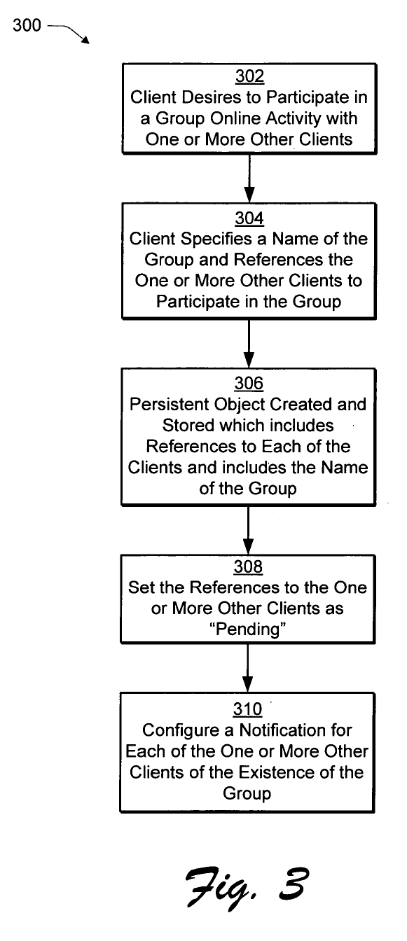

The persistent object 126(p) may be utilized to provide a variety of functionality. For example, by providing for persistence of client references 128(h) in the persistent object 126(p), the persistent object 126(p) may be reused to invite the clients 104(1)-104(N) to participate in the online activity 112(k) without having to perform a plurality of manual steps, such as to select which of clients 104(1)-104(N) are to participate in the online activity, sending notifications that participation in the online activity 112(k) is desired, and so on. Additionally, the persistent object 126(p) may be configured to be callable by any one of the referenced clients. For instance, client 104(2) may leverage the persistent object 126(p) which was created by client 104(1). Further, each client that is referenced by the persistent object 126(p) may be permitted to include a reference of another client, thereby increasing membership of a group described by the persistent object. A variety of other functionality may also be provided through examination of the persistent object 126(p), further discussion of which may be found in relation to FIGS. 3-11.

Although the persistent object system 106 is illustrated as separate from the plurality of clients 104(1)-104(N) and the online activity provider 102(m), the functionality of the persistent object system 106 may be incorporated into the environment 100 in a variety of ways. For example, the plurality of clients 104(1)-104(N) may incorporate the functionality of the persistent object system 106 such that communication over the network 110 is not required. In another example, the persistent object system 106 may be incorporated by the online activity provider 102(m), an example of which is shown in relation to FIG. 2.

The environment 100 may also incorporate the functionality of the authentication system 108 to verify that the clients 104(1)-104(N) “are who they say they are”. For example, the authentication system 108 may include storage 132 for a plurality of client accounts 134(i), where “i” can be any integer from one to “I”. Each of the client accounts 134(i) may include information for verifying the identity of a corresponding one of a plurality of clients 104(1)-104(N). Therefore, the identity of the clients 104(1)-104(N) may be established before permitting the clients 104(1)-104(N) to participate in the online activity 112(k), which protects against uninvited clients from participating in the online activity.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the persistent object techniques described below are platform-independent, meaning that the techniques may be implemented on a variety of commercial computing platforms having a variety of processors.

FIG. 2 is an illustration of a system 200 in an exemplary implementation showing the online activity provider 102(m), the clients 104(1), 104(2), the persistent object system 106, and the authentication system 108 in greater detail as implementing an online activity to provide instant messaging. The online activity provider 102(m) is illustrated as implemented by a messaging server 202, the authentication system 108 is illustrated as implemented by an authentication server 204, and the clients 104(1), 104(2) are illustrated as client devices. The messaging server 202, authentication server 204, and the clients 104(1), 104(2) are each illustrated as having a respective processor 206, 208, 210(1), 210(2) and a respective memory 212, 214, 216(1), 216(2).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 212, 214, 216(1), 216(2) is shown, respectively, for the messaging server 202, the authentication server 204, and the clients 104(1), 104(2), a wide variety of types and combinations of memory may be employed, such as random access memory (RAM), hard disk memory, removable medium memory, and so forth.

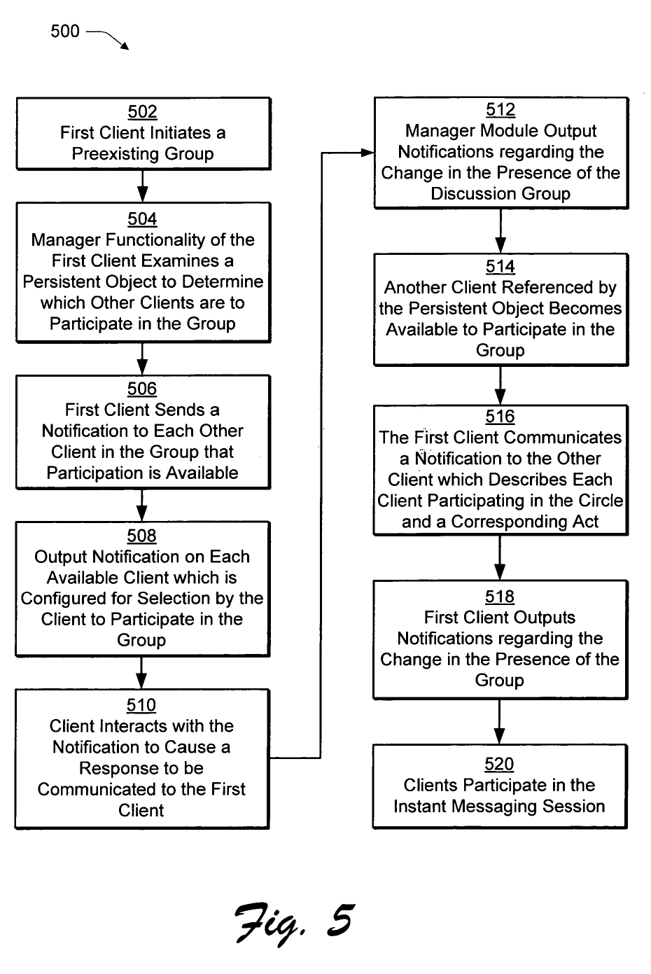

Instant messaging is a popular communication tool that enables two or more clients (e.g., clients 104(1), 104(2)) to exchange messages via a network. For instance, when the clients 104(1), 104(2) are available at the same time over a network (e.g., a peer-to-peer network), instant messages may be exchanged in real time between the two users. In this way, the instant messages may be utilized to support a text conversation between the two users in a manner that mimics how the two clients 104(1), 104(2) would participate in a typical spoken conversation. Although two clients 104(1), 104(2) are illustrated in FIG. 2, an instant messaging session may support more than two clients, an example of which is described in relation to FIGS. 5-11.

Each of the clients 104(1), 104(2) includes a respective one of a plurality of messaging modules 218(1), 218(2) which correspond to a particular implementation of the respective communication modules 122(1), 122(2) of FIG. 1. Each of the messaging modules 218(1), 218(2) is executable such that a respective one of the clients 104(1), 104(2) may participate in an instant messaging session. For example, the messaging module 218(1), 218(2) may be executed by the respective clients 104(1), 104(2) to send text messages and graphics (e.g., emoticons) to each other. The instant messages are typically communicated in real time, although delayed delivery may also be utilized, such as by logging the text messages when one of the clients 104(1), 104(2) is unavailable, e.g., offline. Thus, instant messaging may be though of as a combination of e-mail and Internet chat in that instant messaging supports message exchange and may be utilized for synchronous communication, e.g., is designed for two-way live chats. For instance, like a voice telephone call, an instant messaging session may be performed in real-time such that each client may respond to each other client as the instant messages are received.

In an implementation, the messaging modules 218(1), 218(2) communicate with each other through use of the messaging server 202. The messaging server 202, for instance, may include a messaging manager module 220 (hereinafter “manager module”) which is executable thereon to route instant messages between the messaging modules 218(1), 218(2). For instance, the client 104(1) may execute the messaging module 218(1) on the processor 210(1) to form an instant message for communication to client 104(2). The messaging module 218(1), when executed, communicates the instant message to the messaging server 202, which then executes the manager module 220 to route the instant message to the client 104(2) over the network 110. The client 104(2) receives the instant message and executes the messaging module 218(2) to display the instant message.

In another instance, when the clients 104(1), 104(2) are communicatively coupled directly, one to another (e.g., via a peer-to-peer network 222), the instant messages are communicated without utilizing the messaging server 202. Thus, as previously stated, the messaging modules 218(1), 218(2) are executable to provide an instant messaging session, either in indirect communication through use of the messaging server 202 over the network 110 and/or directly over a peer-to-peer network 222, which is illustrated in FIG. 2 by a double-headed arrow to indicate that the peer-to-peer network 222 may be utilized without communicating through the messaging server 202.

In the system 200 of FIG. 2, the messaging server 202 is illustrated as incorporating the functionality of the persistent object system 106 by including storage 124 in the memory 212 for the plurality of persistent objects 126(p) of FIG. 1. Each persistent object 126(p) includes a plurality of client references 128(h) and a description of a client act 224(h) performed by the referenced client. For example, the client act 224(h) may describe the most recent text message sent by the client referenced by the client reference 128(h).

The persistent objects 126(p) may be configured to provide a variety of different functionality. The persistent object 126(p), for instance, may be examined by the manager module 220 in response to a request from the client 104(1) to initiate a group to perform of an online activity, which is this instance is an instant messaging session. The manager module 220 is illustrated as including a connection module 226 which represents functionality for managing a communicative connection between the clients 104(1), 104(2) and the messaging server 202, and thus may act as a “switchboard” between the clients 104(1), 104(2) themselves, as well as the clients 104(1), 104(2) with the messaging server 202.

Once the client 104(1) has successfully obtained a connection with the messaging server 202, the client 104(1) may request initiation of a group online activity of clients referenced by the persistent object 126(p). Therefore, the manager module 220 may be executed to query the persistent object 126(p) to determine which other clients are to participate in the online activity. Based on this determination, the manager module 220 may select one or more of a plurality of notifications 228(a), where “a” can be any integer from one to “A”, for communication to the referenced clients.

The manager module 220, for example, may select a notification 228(a) from storage 230 in the memory 212 for communication over the network 110 to client 104(2). The notification may then be output through execution of the messaging module 218(2) on the client 104(2). The client 104(2) may then decide whether to participate in the instant messaging session based on the notification. In this example, the persistent object 126(p) is utilized to form the notification 228(a) which includes an identification of each of the clients which are to participate in the online activity, i.e., which clients were invited to participate in the online activity. If the client 104(2) is not currently available, the notification 228(a) may be stored for later output by the client 104(2). For example, the notification 228(a) may be sent via email for output by an email module 232(2) the next time the client 104(2) accesses the network 110. A variety of other techniques may also be employed, further discussion of which may be found in relation to FIGS. 5-11.

The manager module 220 is also illustrated as including a presence module 234. The presence module 234 represents functionality for determining which of the clients are currently participating in the online activity. For example, the presence module 232 may be executed to monitor which of the clients “log on” and “log off” the messaging server 202 to participate in the instant messaging session. In another example, the presence module 234 may also be executed to determine which acts are being and/or were performed by participants in the instant messaging session. For instance, the presence module 234 may determine that the client 104(1) is participating in the instant messaging session and is also playing an online game with another client during the instant messaging session. In another instance, the presence module 234 may track instant messages sent by each of the clients.

The presence module 234 may store data for later retrieval. For example, the present module 234 may store this data as a part of the persistent object 126(p) as illustrated, may store this data separately from the persistent object 126(p), and so on. For instance, the manager module 220 (and more particularly the presence module 234) may be configured such that the client act 224(h) data is not persisted in the persistent object 126(p), but rather is stored separately from the persistent object 126(p). Therefore, the client act 224(h) data may be erased when the instant messaging session is terminated without affecting the persistent object 126(p). A variety of other instances are also contemplated.

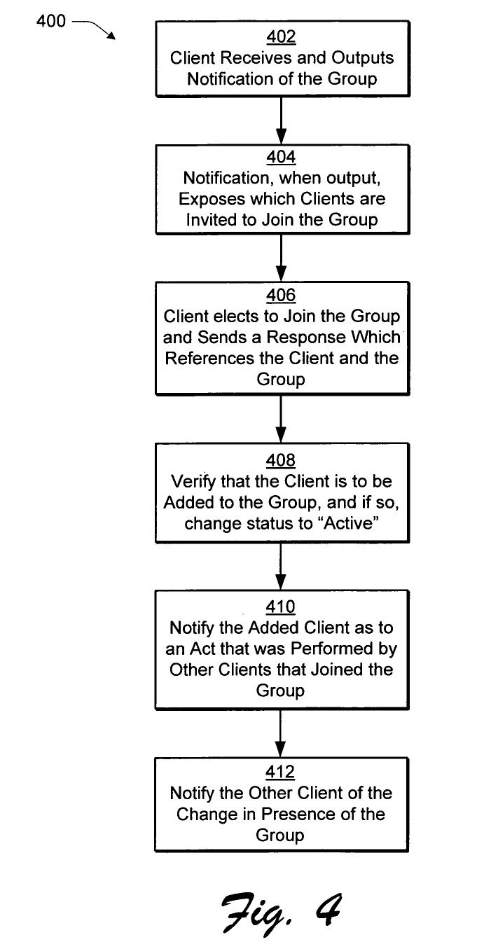

The client act 224(h) data may also be utilized to provide a variety of other functionality. Continuing with the previous example in which client 104(2) was invited to participate in an instant messaging session with client 104(1), when the client 104(2) “logs on” to the messaging server 202 to participate in the instant messaging session, the presence module 234 may communicate client act 224(h) data in another one of the plurality of notifications 228(a) to client 104(2). Therefore, this other notification may describe acts being performed and/or were performed by other clients (e.g., client 104(1)) which are already participating in the instant messaging session. In this way, the client 104(2) may be brought “up-to-date” as to the current status of the online activity. Further discussion of communication of the other notification to the client when joining the online activity may be found in relation to FIGS. 4, 9 and 11.

To verify identity of the client 104(2) before participation in the online activity (e.g., the instant messaging session), the manager module 220 may utilize the authentication system 108. For example, the manager module 220 may redirect the client 104(2) to the authentication system 108 when the client 104(2) attempts to logon to the messaging server 202. The authentication system 108 may execute an authentication module 236 on the processor 208 to verify the identity of the client 104(2), such as by utilizing a user login ID 238 and password 240 contained in a client account 134(i) which corresponds to the client 104(2). A result of the authentication may then be communicated to the manager module 220 for determining whether the manager module 220 should permit the client 104(2) to participate in the instant messaging session. Thus, the instant messaging session may be protected against intruders and therefore include clients which are referenced in the persistent object 126(p).

Exemplary Procedures

The following discussion describes persistent object techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 is a flow diagram depicting a procedure 300 in an exemplary implementation in which a persistent object is created by a client to automatically cause notifications to be configured for other clients referenced by the persistent object. First, a client desires to participate in a group online activity with one or more other clients (block 302). For example, the client may wish to form an online meeting that includes the client and the other clients, participate in an instant messaging session, provide a presentation for viewing by other clients and for receiving comments from the other clients, and so on.

The client may specify a name of the group and provide a reference (e.g., a network address) to the one or more other clients which are to participate in the group (block 304). For example, the client may name the group such that the other clients can readily determine a purpose of the online activity (e.g., poker, meeting to discuss <topic>, and so on) and provide a network address (e.g., an email address) for locating each of the other clients.

A persistent object is then created and stored which includes references to each of the clients and which includes the name of the group (block 306). For example, the communication module 122(1) may be executed to provide a user interface, from which, the client may receive the name of the group and the network addresses. In another example, the specifying and the creation of the persistent object may be performed automatically. For instance, the client may be actively participating in the online activity with the other clients. The client may then receive an input which selects a “create group” function. By selecting the “create group” function, the client may automatically create a persistent object which includes a reference to each client that is currently participating in the online activity and a name of the online activity. In another instance, the persistent object includes a reference to each client that has participated in the online activity during a session of the online activity. Thus, in these instances, the client does not manually provide the references (e.g., network addresses) of the client and the other client. A variety of other techniques may also be utilized to create the persistent object.

After creation of the persistent object, references to the one or more other clients are set as “pending” (block 308). A notification is also configured for each of the other clients (i.e., the “pending” clients) to invite the other clients to participate in the online activity (block 310). For example, the other 130 data in the persistent object 126(p) may describe whether a client referenced by the persistent object 126(p) has accepted the invitation to participate in the online activity, has rejected the invitation, has not yet responded to the invitation, and so on. This information may describe the “presence” of the group in relation to the online activity, and may be communicated to the clients to apprise the clients as to a state of participation in the online activity. Further discussion of presence of the group may be found in relation to the following figure.

FIG. 4 is a flow diagram depicting a procedure 400 in an exemplary implementation in which a client receives a notification configured by the procedure 300 of FIG. 3 to participate in an online activity. A client receives and outputs a notification of the group (block 402). For example, client 104(2) may receive a notification from the messaging server 202 of a group which is being formed to participate in an online activity which was initiated by client 104(1). The notification, when output, exposes which clients are invited to join the group (block 404). For example, the notification may include each client reference 128(h) included in the persistent object 126(p) which was utilized to form the group. The notification may also indicate which client initiated the group, since the client is likely to be available for active participation in the online activity.

Based on the output, the client elects to join the group and sends a response which references the client and the group (block 406). For example, the client may reply to the notification. The reply may reference the client and indicate whether the client wishes to participate in the online activity. In an implementation, the reply may be automatically formed from the notification. For example, the notification may include buttons for accepting or declining participation in the online activity, the selection of which causes the reply to be configured and communicated back to the messaging server 202.

The client is then verified for participation in the online activity, and if so, the status of the client is changed to “active” (block 408). For example, the messaging server 202 may communicate with the authentication system 108 to determine whether the identity of the client is valid, such as by comparing a user login ID 238 and password 240. The messaging server 202 may also compare the identity to the client reference 128(h) to determine whether the client is permitted to join the group. If the client is permitted and is valid, the messaging server 202 may set the client's status to “active” indicating that the client is now able to participate in the online activity.

The added client is then notified as to an act that was performed by other clients that joined the group (block 410). For example, the notification may be formed for communication to the added client which describes acts that were performed by other clients in conjunction with the online activity before the added client joined the group, such as a most recent instant message, change in status (e.g., the other client just joined the group), and so on.

The other clients are also notified of the change in presence of the group (block 412). For example, notifications may be sent to each client that is currently participating in the group that the added client just joined the group. Thus, each client that participates in the group may be kept informed as to the presence (e.g., membership) of the group with respect to the online activity.

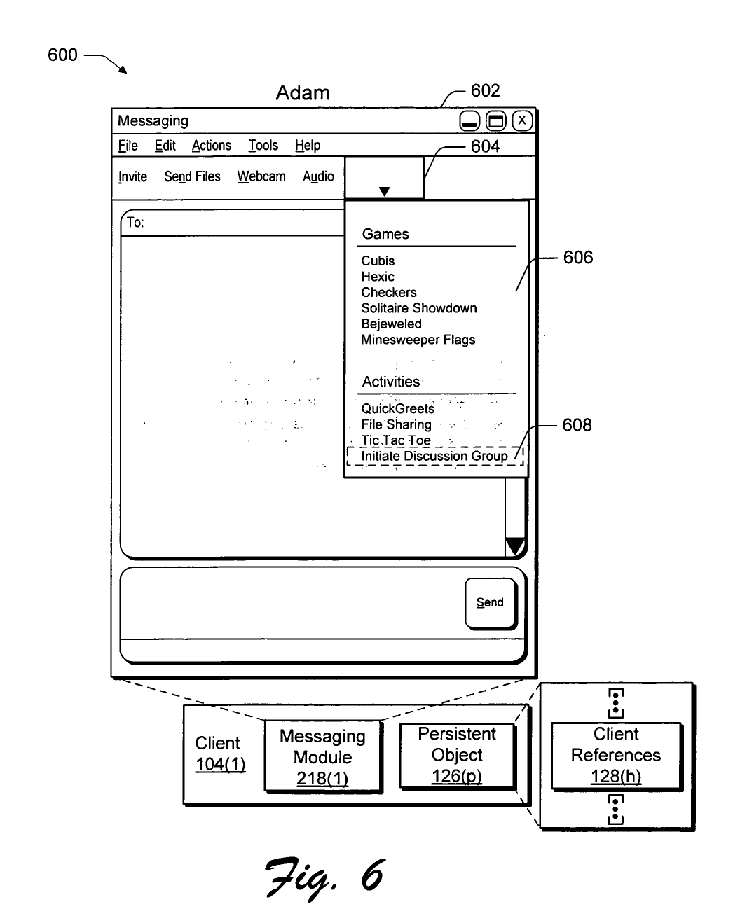

FIG. 5 is a flow diagram depicting a procedure 500 in an exemplary implementation in which an instant messaging session is initiated for participation by a plurality of clients over a peer-to-peer network. During the discussion of procedure 500, reference will also be made to the exemplary implementations of FIGS. 6-11.

A first client 104(1) initiates a preexisting group (block 502). For example, FIG. 6 is an illustration of an exemplary implementation 600 in which the client 104(1) executes the messaging module 218(1) to output a user interface 602 for initiating participation in a discussion group in conjunction with an instant messaging session. The user interface 602 includes a launch menu item 604, which when selected, causes display of a drop-down menu 606 which includes a plurality of items for selection by the client 104(1). One such item is illustrated as “initiate discussion group” 608, which when selected, causes the messaging module 218(1) to initiate an instant messaging session between a plurality of clients referenced by the persistent object 126(p). Thus, the messaging module 218(1) in this instance incorporates the manager module 220 functionality to examine the persistent object to determine which other clients are to participate in the group (block 504).

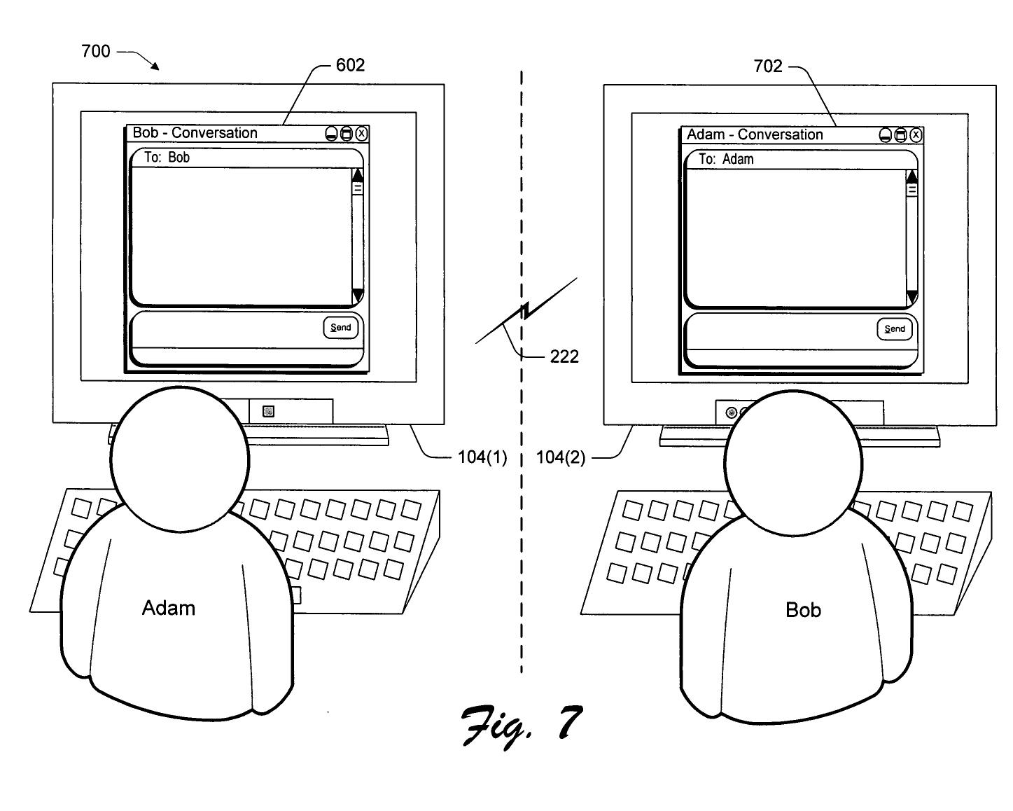

The first client then sends a notification to each other client referenced by the persistent object 126(p) that participation in the group is available (block 506). For example, FIG. 7 is an illustration of an exemplary implementation 700 in which client 104(1) of FIG. 6 is communicatively coupled to another client 104(2) over the peer-to-peer network 222. The other client 104(2) in this instance is referenced by the persistent object 126(p) of FIG. 6, and likewise includes a user interface 702 for output. Client 104(1) is illustrated as being utilized by “Adam” and client 104(2) is illustrated as being utilized by “Bob”. Client 104(1) sends the notification over the network 222 to client 104(2) for output.

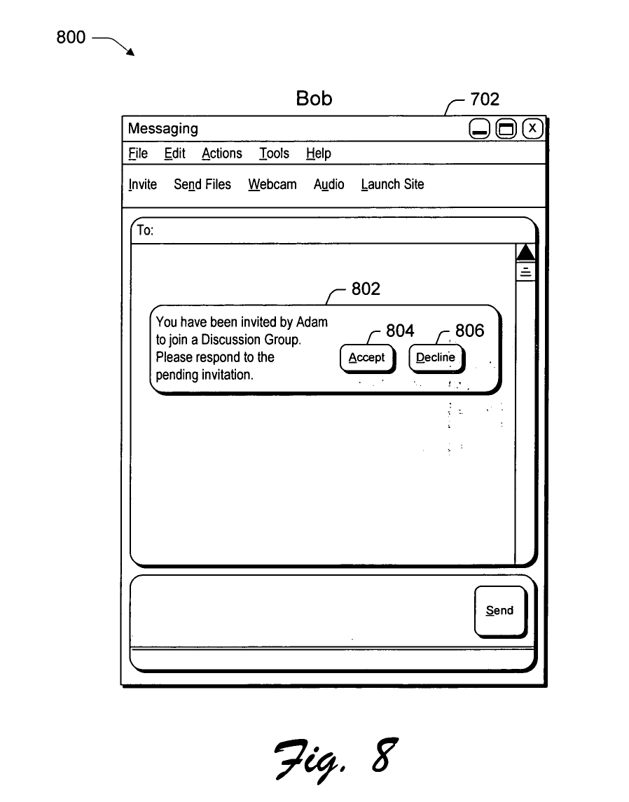

The notification is output on each available client which is configured for selection by the client to participate in the group (block 508). FIG. 8, for instance, is an illustration of an exemplary implementation 800 in which the user interface 702 of the other client 104(2) of FIG. 7 is shown as outputting the notification 802 received from the client. The notification 802 in this instance indicates an originator of the invitation (e.g., Adam). The notification 802 is also illustrated as including an “accept” 804 button and a “decline” 806 button. Selection of the decline button causes a response to be communicated to the client 104(1) (e.g., Adam) that the other client 104(1) (e.g., Bob) does not wish to participate in the discussion group.

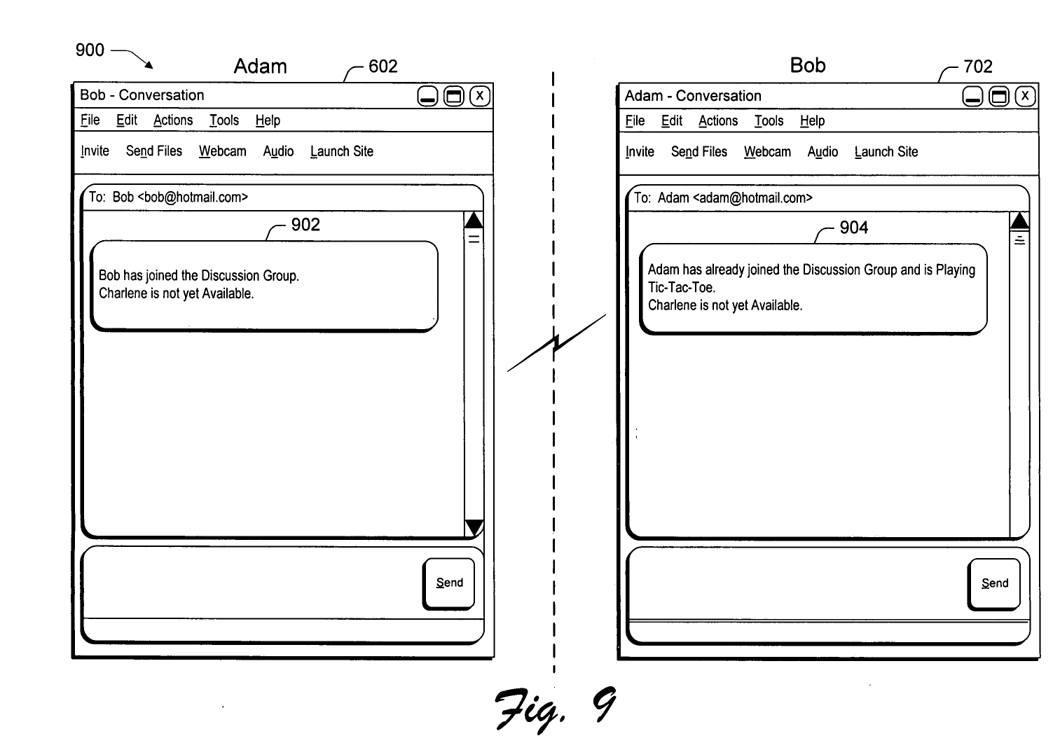

The client may also interact with the notification (e.g., select the accept button 804) to cause a response to be communicated to the first client 104(1) indicating acceptance of the invitation (block 510). The first client 104(1) then outputs notifications regarding the change in presence of the discussion group (block 512). FIG. 9, for example, is an illustration of an exemplary implementation 900 in which the user interface 602 of the first client 104(1) and the user interface 702 of the second client 104(2) output notifications 902, 904 which relate to the change in presence of the discussion group.

The notification 902 output by the first client 104(1) in the user interface 602 describes that Bob has joined the discussion group, but another client referenced by the persistent object 126(g) (illustrated as “Charlene”) is not yet available. Thus, Adam is informed as to the current membership of the discussion group.

The notification 904 output by the second client 104(2) also describes the current membership of the discussion group. In addition, because the second client has just joined the discussion group, the notification 904 may also describes acts which were performed by one or more participants of the discussion group, which is illustrated in FIG. 9 that Adam is “playing Tic-Tac-Toe”. Thus, the joining client (i.e., Bob) is informed as to who is participating in the online activity and acts being performed in conjunction with the online activity.

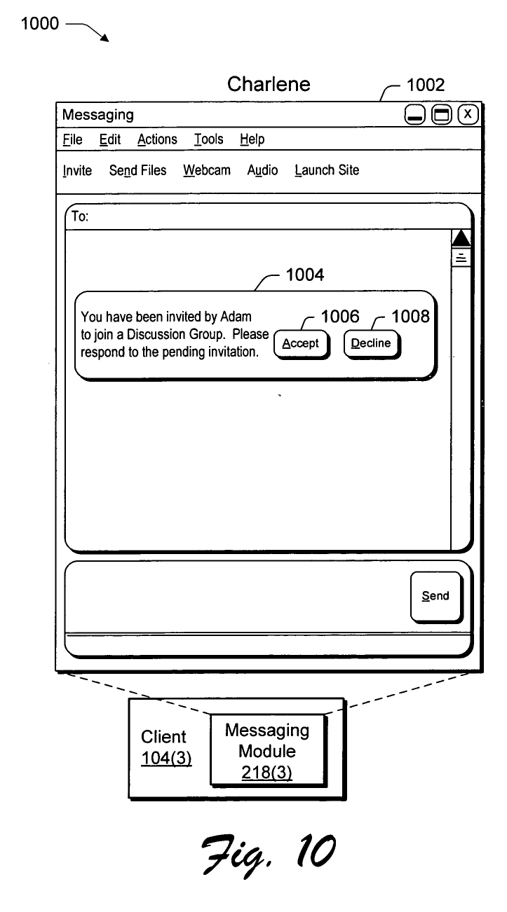

Another client referenced by the persistent object then becomes available to participate in the group (block 514). FIG. 10, for example, is an illustration of an exemplary implementation 1000 in which another one of the plurality of clients 104(1)-104(N) of FIG. 2, when available to participate in the instant messaging session, outputs a notification 1002 received from the first client 104(1). In this implementation, the third client 104(3) was not available when the first client 104(1) sent out the notification that participation in the group was available (block 506). Instead, the notification 1004 was stored in a queue for output by the third client 104(3), through execution of the messaging module 218(3), when the third client 104(3) became available. The notification 1004 is similar to the notification 802 of FIG. 8, and includes an accept 1006 button and a decline 1008 button. As before, selection of either button causes a response to be sent to the first client 104(1) which indicates whether the third client 104(3) has accepted or declined the invitation.

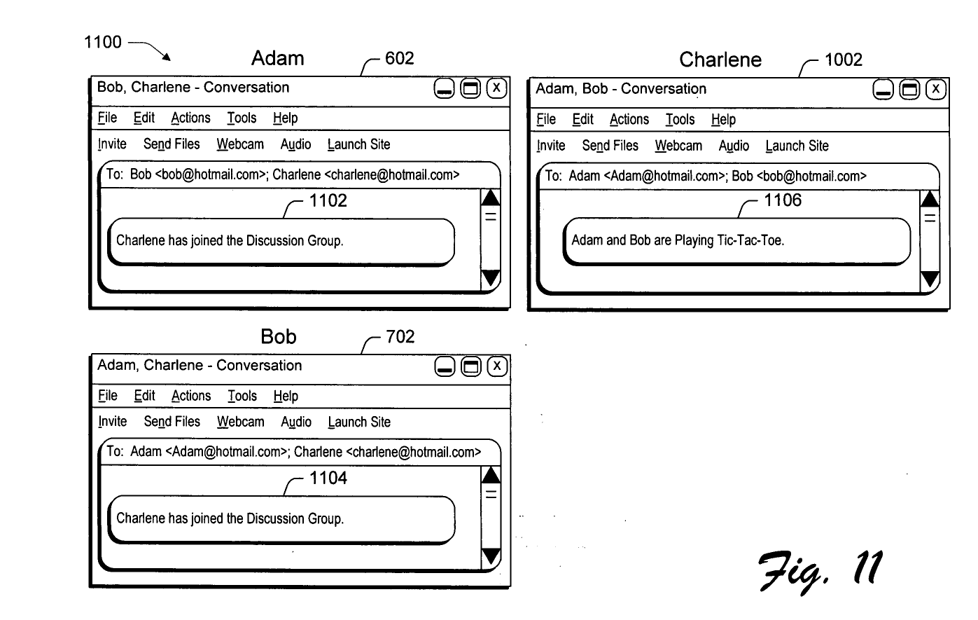

For example, upon receipt of a response which accepts participation in the group, the first client communicates a notification to the other client (e.g., the third client) which describes each client that is participating in the group and a corresponding action performed by the client (block 516). Additionally, the first client outputs a notification regarding the change in presence of the group (block 518). FIG. 11, for instance, is an illustration of an exemplary embodiment 1100 in which user interfaces 602, 702, and 1002 are shown for the respective first, second, and third clients 104(1)-104(3) which relate to the change in presence of the group.

The user interface 602 of the first client (e.g., Adam) outputs a notification 1102 which indicates that the third client (i.e., Charlene) has joined the discussion group. Likewise, the user interface 702 of the second client (e.g., Bob) also outputs a notification 1004 which indicates that the third client (i.e., Charlene) has joined the discussion group. A notification 1106 output in the user interface of the third client (e.g., Charlene) indicates that both Adam and Bob are playing Tic-Tac-Toe, and thus are both currently participating in the online activity. At this point, each of the clients (i.e., Adam, Bob, and Charlene) can participate in the instant messaging session (block 520).

Although the procedure 500 and implementations 600, 700, 800, 900, 1000, 1110 of FIGS. 5-11 were described in relation to an instant messaging session performed over a peer-to-peer network, similar functionality may be employed by the messaging server 202 of FIG. 2 without departing from the spirit and scope thereof.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claim invention.

What is claimed is:

1. A method comprising:
creating a persistent object which references a plurality of clients for participation in an online activity over a network; and
storing the persistent object to be callable by at least one said client for:
initiating the online activity; and
causing a notification to be formed for communication over the network to each other said client to participate in the online activity.

2. A method as described in claim 1, wherein the persistent object is persistent, such that, the persistent object continues to exist beyond termination of execution of a module that created the persistent object.

3. A method as described in claim 1, wherein the persistent object is storable in a system which is accessible over the network by each said client.

4. A method as described in claim 1, wherein the persistent object is storable by one or more of the plurality of clients.

5. A method as described in claim 1, wherein the persistent object is callable to automatically cause the creating and the causing to be performed without user intervention.

6. A method as described in claim 1, wherein the online activity includes instant messaging.

7. A method as described in claim 1, wherein the online activity includes an activity selected from the group consisting of:
a game;
a presentation; and
a meeting.

8. A method as described in claim 1, wherein the network is configured to include a peer-to-peer network.

9. A method as described in claim 1, further comprising:
communicating each said notification to a respective said client; and
forming another notification for each said client that is participating in the online activity when a change in presence of one or more said clients in relation to the online activity occurs.

10. A method as described in claim 9, wherein the change in presence includes adding the one or more said clients to participate in the online activity or removing the one or more said client from participating in the online activity.

11. A method as described in claim 1, further comprising storing the formed notification when a corresponding said client is not available to receive the formed notification.

12. A method comprising examining a persistent object to:
locate a plurality of clients which are to participate in an instant messaging session; and
form a notification for communication to one or more said clients, wherein the notification indicates that participation in the instant messaging session is available.

13. A method as described in claim 12, wherein the persistent object is persistent, such that, the persistent object continues to exist beyond termination of execution of a module that created the persistent object.

14. A method as described in claim 12, wherein the examining further includes forming another notification for each said client that is participating in the instant messaging session when a change in presence of clients in relation to the instant messaging session occurs.

15. A method as described in claim 12, further comprising:
storing the formed notification when a corresponding said client is not available to receive the formed notification; and
communicating the stored notification when the corresponding said client is available.

16. A method as described in claim 12, wherein the notification is selectable to automatically join the instant messaging session.

17. A method comprising:
forming a response to a request, wherein:
the request is for a client to participate in an online activity over a network;
one or more other clients are participating in the online activity;
the request is formed based on examination of a persistent object which references each said client; and
the response indicates that participation in the online activity is desired; and
receiving a notification as a result of the response which describes an act performed by the one or more other clients as a part of the online activity.

18. A method as described in claim 17, wherein the persistent object is persistent, such that, the persistent object continues to exist beyond termination of execution of a module that created the persistent object.

19. A method as described in claim 17, wherein the online activity includes an activity selected from the group consisting of:
instant messaging;
a game;
a presentation; and
a meeting.

20. A method as described in claim 17, further comprising forming a notification for each of the one or more other clients which indicates that the client is participating in the online activity.
